(19) United States
(12) Patent Application Publication
(10) Pub. No.: US 2005/0036875 A1
(43) Pub. Date: Feb. 17, 2005

(54) Bucket attachment for loader

(76) Inventor: Bruce Downing, Plano, TX (US)

Correspondence Address: Steven Thrasher, 391 Sandhill Dr., Richardson, TX, 75080, US

(21) Appl. No.: 10/642,411

(22) Filed: Aug. 15, 2003

(51) Int. Cl. B66F 9/00

(52) U.S. Cl. 414/722

(57) ABSTRACT

The invention provides a loader attachment for a loader having a plurality of skids. The attachment includes a bucket configured for attachment to a loader, a pourer portion coupled to the front of the bucket, and a skid adaptor configured at the rear of the bucket.

### TECHNICAL FIELD

The invention relates generally to loaders, and more specifically the invention relates to loaders having skids. More specifically still, the invention relates to bucket attachments for industrial loaders having skids.

### STATEMENT OF A PROBLEM ADDRESSED BY THE INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Loaders, such as the BOBCAT® 763 skid-steer loader are well known in the construction and earth excavation industries. Loaders include wheel steer loaders, track loaders, compact track loaders, and skid-steer loaders, for example. Construction and earth excavation professionals like loaders because they offer a low-maintenance and low-cost way to quickly and powerfully perform projects which are not large enough to warrant the use of larger, more expensive construction equipment.

One distinguishing feature of loaders is that they have skids. Skids are the parallel “fingers” on the front portion of a loader. Skids are often seen in warehouse settings sliding underneath a pallet so that the pallet may be lifted and moved. Skids may operate in horizontal or vertical configurations depending on the type of loader and its use.

In the earth construction and excavation industries there exists many loader attachments, many of which attach to loader skids. These attachments allow the loader to accomplish a specific application(s). One such attachment is a bucket. There are many application specific buckets, such as low profile buckets, light material buckets, fertilizer buckets, and construction-industrial buckets. However, there exist needs for additional bucket attachments to offer loader operators more control in various loader operations. The present invention provides multiple embodiments of an inventive bucket attachment.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings.

FIG. 1 is a block diagram of an inventive loader attachment for a loader.

FIG. 2a illustrates a loader attachment with an inventive pourer portion.

FIG. 2b provides a top-down view of the loader attachment.

FIG. 3a shows an alternative embodiment of an inventive loader attachment.

FIG. 3b is a top-down view of the alternative loader attachment of FIG. 3a.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section.

Discussion of the Drawings

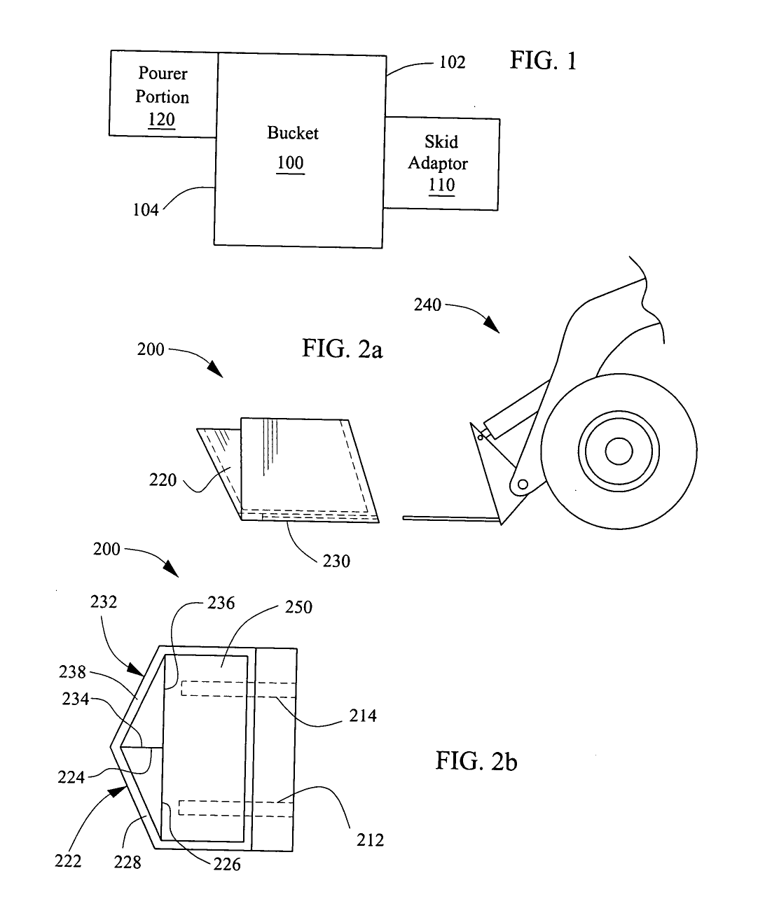

The features and advantages of the invention can be better understood by reviewing FIG. 1, which is a block diagram of an inventive loader attachment or a loader. The attachment generally includes a pourer portion 120, a bucket 100 and a skid adapter 110. The pourer portion 120 is any device or system, which provides for general directionally control of a liquid flowing from the bucket 100. The bucket 100 is generally similar to existing bucket attachments for loaders, and similarly the skid adapter 110 may utilize any existing systems, devices, or methods of adaptation for allowing a bucket attachment to couple to the skids of a loader. Accordingly, the invention can be characterized as a loader attachment for a loader having a plurality of skids, the attachment for controlling the pouring of a material from a bucket. In general, the bucket is defined has having a rear portion which is the portion of the bucket closest to a loader when the attachment is attached to the loader, and a front which is defined as the portion of the bucket opposite the rear.

FIG. 2a illustrates a loader attachment with an inventive pourer portion 220, and FIG. 2b provides a top-down view of the loader attachment 200. In FIG. 2a one may see that the loader attachment 200 couples to the skids 230 of a loader 240. Any of the existing systems or methods of coupling a loader attachment to a loader a readily adaptable to the present invention, and are incorporated herein. From FIG. 2b, it is seen that the loader attachment 200 comprises a first skid channel 212 and a second skid channel 214 which are substantially horizontal, and substantially parallel. Of course, when in operation, the skid channels will change their orientation so that a liquid may pour from the bucket and out the pourer portion. However, it should be understood that in some embodiments of loader attachments the skids channels are substantially vertical, and such channels may be utilized in the present invention with out departing from the scope or spirit of the invention. Additionally, the skid adapter 110 may comprise a plurality of loops, or a plurality of brackets, or a combination of loops and brackets, which are adapted to couple to a skid. The loops and brackets are then preferably coupled to the rear portion of the bucket.

From FIG. 2b it can be seen that the pourer portion may include a first triangular section 222 having a first edge 224 and a second edge 226 and a top 228 and a second triangular section 232 having a first edge 234 a second edge 236 and a top 238. Here, the first edge 224 of the first triangular section 222 is coupled to the first edge 234 of the second triangular section 232, and the second edge 226 of the first triangular section 222 is coupled to the bucket 250, while the second edge 236 of the second triangular portion 232 is also coupled to the bucket 250. As is seen in FIG. 2b preferably, the bucket and pourer are intrical, meaning that they are formed from a single continuous housing. However, it should be understood that the pourer may comprise a first triangular section and a second triangular section, which are welded or otherwise coupled to the bucket 250 as separate portions.

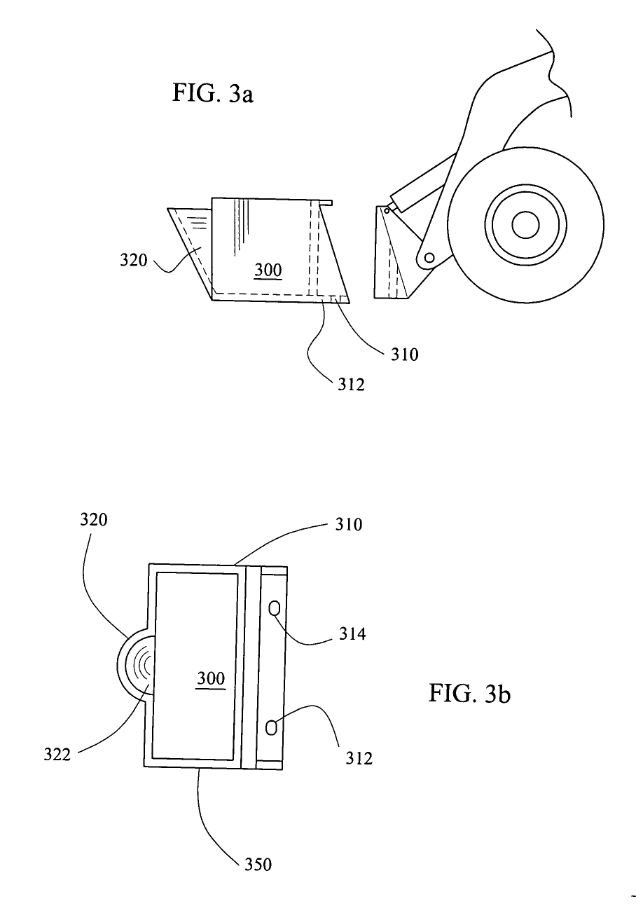

FIG. 3a shows an alternative embodiment of an inventive loader attachment 300. The attachment 300 comprises a pourer 320, which is shaped substantially like a conical section, such that the conical section is coupled to the bucket 350 at the cut of the conical section 320. Additionally, it is noted that in FIG. 3a the skid adapters 312 are substantially vertically orientated. Further, a flange 310 is provided through which additional coupling means may be induced to allow the loader attachment to more effectively couple to a loader. For example, the flange 310 may include means for rotatively coupling hydraulic cylinders to the loader attachment, toolboxes, spare parts, or other accessories.

FIG. 3b is a top-down view of the alternative loader attachment of FIG. 3a. In FIG. 3b one may see that a channel 322 is disposed between the front of the bucket 350 and the pourer portion 320. The channel 322 is preferably disposed in a lower portion of the front of the bucket so that substantially all of any liquid may be poured from the bucket and out of the pourer portion 320. Accordingly, the channel 322 is preferably adapted to allow a liquid to flow between the bucket 350 and the pourer portion 320. Accordingly, in a preferred embodiment, the channel 322 is substantially shaped like the cross section formed by the inter-section of the pourer portion 320 with the bucket 350. Also from FIG. 3b it is seen that the first skid channel 312 and the second skid channel 314 extend vertically through the flange 310.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

Further, other features and embodiments of the invention will be apparent to those of ordinary skill in the art. After reading this specification, including the Exemplary Embodiment, these persons will recognize that similar results can be achieved in not dissimilar ways. Accordingly, the Exemplary Embodiment is provided as an example of the best mode of the invention, and it should be understood that the invention is not limited by it, but, rather, the invention should be read as being limited only by the claims.

1. A loader attachment for a loader having a plurality of skids, the attachment for controlling the pouring of a material from the bucket, comprising:
a bucket configured for attachment to a loader, the bucket having a front and a rear;
a pourer portion, separate from the lip and extending from the lip, coupled to the front of the bucket at the top of the bucket; and
a skid adaptor configured at the rear of the bucket.

2. The attachment of claim 1 further comprising a channel disposed between the front of the bucket and the pourer portion.

3. The attachment of claim 2 wherein the channel is further disposed in a lower portion of the front of the bucket, and wherein said channel is adapted to allow a liquid flow between the bucket and the pourer portion.

4. The attachment of claim 2 wherein the channel is substantially shaped like an intersection cross-section of the pourer portion.

5. The attachment of claim 1 wherein the skid adaptor comprises a first skid channel and a second skid channel.

6. The attachment of claim 5 wherein the skid channels are substantially horizontal.

7. The attachment of claim 5 wherein the skid channels are substantially vertical.

8. The attachment of claim 1 wherein the pourer portion comprises a conical section, the conical section being coupled to the bucket at the cut of the conical section.

9. The attachment of claim 1 wherein the skid adaptor is coupled to the back of the bucket.

10. The attachment of claim 9 wherein the skid adaptor comprises a plurality of loops, each loop being adapted to couple to a skid.

11. The attachment of claim 1 wherein the pourer portion comprises:
a first triangular section having a first edge, a second edge and a top;
a second triangular section having a first edge, a second edge and a top;
the first edge of the first triangular section being coupled to the first edge of the second triangular section; and
the second edge of the first triangular section being coupled to the bucket, and the second edge of the second triangular section being coupled to the bucket.

12. The attachment of claim 1 wherein the bucket and pourer portion are integral.

13. The attachment of claim 1 wherein the skid adaptor system has a first brace and a second brace, each of the first brace and the second brace is adapted to receive a skid.
